(19) United States
(12) Patent Application Publication
(10) Pub. No.: US 2026/0289961 A1
(43) Pub. Date: Sep. 24, 2026

(54) Target Detection Method and Target Detection Device, and Storage Medium

(71) Applicants: BOE TECHNOLOGY GROUP CO., LTD., Chaoyang District, Beijing (CN); BEIJING BOE TECHNOLOGY DEVELOPMENT CO., LTD., Beijing (CN)

(72) Inventor: Ding Nie, Beijing (CN)

(21) Appl. No.: 18/996,843

(22) PCT Filed: May 14, 2024
(86) PCT No.: PCT/CN2024/093104

§ 371 Date: Jan. 17, 2025

(30) Foreign Application Priority Data
Jun. 19, 2023 (CN) 202310727996.5

(51) Int. Cl. G06V 10/762; G06V 10/26; G06V 10/764

(52) U.S. Cl. CPC G06V 10/762; G06V 10/26; G06V 10/764; G06V 2201/07

(57) ABSTRACT

The present disclosure provides a target detection method, a target detection device, and a storage medium. The target detection method includes acquiring an image to be processed, wherein the image to be processed includes a plurality of sub-images, detecting a target detection frame in each sub-image among the plurality of the sub-images by a target detection models, clustering target detection frames in the plurality of sub-images to obtain a clustering result, and acquiring a target in the image to be processed according to the clustering result.

### CROSS-REFERENCE TO RELATED APPLICATIONS

This application is the United States national phase of International Patent Application No. PCT/CN2024/093104 filed May 14, 2024, and claims priority to Chinese Patent Application No. 202310727996.5 filed Jun. 19, 2023, the disclosures of which are hereby incorporated by reference in their entireties.

### BACKGROUND OF THE INVENTION

### Field of the Invention

The present disclosure relates to the field of information technology, and in particular to a target detection method, a target detection device, and a storage medium.

### Description of Related Art

Target detection technology refers to identify information understandable to a computer from an input image, including position information, category information, confidence level and so on of the target. At present, target detection technology has been applied to smart security, smart transportation and other fields. In addition, in the field of smart manufacturing, target detection technology can also be used to detect the defect of the target to improve the yield.

At present, the target detection technology is mainly realized in the following ways: firstly, the image is compressed to obtain an image to be detected, and then the image to be detected is input into a trained machine learning model to detect the target in the image to be detected.

### SUMMARY OF THE INVENTION

According to a first aspect of an embodiment of the present disclosure, there is provided an target detection method, comprising: acquiring an image to be processed, wherein the image to be processed comprises a plurality of sub-images; detecting a target detection frame in each sub-image among the plurality of the sub-images by a target detection model; clustering target detection frames in the plurality of the sub-images to obtain a clustering result; and acquiring a target in the image to be processed according to the clustering result.

In some embodiments, the clustering the target detection frames in the plurality of the sub-images comprises: merging the plurality of the sub-images; and clustering adjacent target detection frames with opposite direction attributes.

In some embodiments, the adjacent target detection frames are of the same detection frame type, and a distance between centers of the adjacent target detection frames is less than a distance threshold.

In some embodiments, the merging the plurality of the sub-images comprises: merging sub-images in each sub-image row of the image to be processed along a first direction, to cluster a first target detection frame, of which direction attribute is the first direction and an adjacent second target detection frame, of which direction attribute is opposite to the first direction; and merging sub-image rows of the image to be processed along a second direction to cluster a third target detection frame, of which direction attribute is the second direction and an adjacent fourth target detection frame, of which direction attribute is opposite to the second direction, wherein the second direction intersects with the first direction.

In some embodiments, the merging the sub-images along the first direction comprises: detecting a direction attribute of the target detection frame in the each sub-image; taking a first sub-image in the first direction as a merging sub-image; performing a first merging process on the merging sub-image and an adjacent second sub-image in the first direction, to update the merging sub-image; detecting a direction attribute of a current target detection frame in the merging sub-image; and repeatedly performing the first merging process until the merging sub-image has no adjacent second sub-image in the first direction.

In some embodiments, the merging the sub-image rows along the second direction comprises: taking a first sub-image row in the second direction as a merging sub-image row; performing a second merging process on the merging sub-image row and an adjacent second sub-image row in the second direction, to update the merging sub-image row; detecting a direction attribute of a current target detection frame in the merging sub-image row; and repeatedly performing the second merging process until the merging sub-image row has no adjacent second sub-image row in the second direction.

In some embodiments, two sides of the first target detection frame parallel to the first direction intersect with one side of a sub-image where the first target detection frame is located in the first direction; two sides of the second target detection frame parallel to the first direction intersect with one side of a sub-image where the second target detection frame is located in an opposite direction of the first direction; two sides of the third target detection frame parallel to the second direction intersect with one side of a sub-image where the third target detection frame is located in the second direction; and two sides of the fourth target detection frame parallel to the second direction intersect with one side of a sub-image where the fourth target detection frame is located in an opposite direction of the second direction.

In some embodiments, the acquiring the image to be processed comprises: dividing an original image to obtain the image to be processed, wherein the image to be processed comprises a plurality of sub-image rows, and one sub-image row comprises a plurality of sub-images with a same size, and sizes of sub-images in the plurality of the sub-image rows decrease sequentially in a direction of depth of field of the original image from small to large.

In some embodiments, the dividing the original image comprises: detecting all target detection frames in the original image; sorting the all target detection frames according to area sizes of the all target detection frames; determining a proportional coefficient according to first n target detection frames and last n target detection frames in a sorting result; determining a height of each sub-image row and a width of the sub-image in the each sub-image row according to the proportional coefficient; dividing the original image in the direction of the depth of field from small to large according to the height of the each sub-image row to obtain the plurality of the sub-image rows; and dividing the each sub-image row according to the width of the sub-image in the each sub-image row.

In some embodiments, the determining the height of the each sub-image row according to the proportional coefficient comprises: determining a transformation parameter of the each sub-image row according to the proportional coefficient; and determining the height of the each sub-image row according to a preset height and the transformation parameter of the each sub-image row.

In some embodiments, the determining the height of the each sub-image row according to the preset height and the transformation parameter of the each sub-image row comprises: calculating a sum of transformation parameters of the plurality of the sub-image rows to obtain a first calculation result; and determining a height of an i-th sub-image row according to the preset height, a transformation parameter of the i-th sub-image row and the first calculation result, wherein 1≤i≤N, and N is a total number of the sub-image rows.

In some embodiments, the height of the i-th sub-image row is positively correlated with the transformation parameter of the i-th sub-image row and inversely correlated with the first calculation result.

In some embodiments, the determining the height of the i-th sub-image row comprises: calculating a ratio of the transformation parameter of the i-th sub-image row to the first calculation result to obtain a second calculation result; and calculating a product of the preset height and the second calculation result to obtain the height of the i-th sub-image row.

In some embodiments, the determining the width of the sub-image of the each sub-image row according to the proportional coefficient comprises: determining the width of the sub-image of the i-th sub-image row according to the preset width and the transformation parameter of the i-th sub-image row.

In some embodiments, the width of the sub-image of the i-th sub-image row is positively correlated with the transformation parameter of the i-th sub-image row.

In some embodiments, the determining the width of the sub-image of the i-th sub-image row comprises: calculating a product of the preset width and the transformation parameter of the i-th sub-image row to obtain the width of the sub-image of the i-th sub-image row.

In some embodiments, the transformation parameter of the i-th sub-image row is an i-th power of the proportional coefficient.

In some embodiments, the determining the proportional coefficient according to the first n target detection frames and the last n target detection frames in the sorting result comprises: determining a m-th scaling coefficient according to a size of a m-th target detection frame in the first n target detection frames and a size of a (n−m+1)-th target detection frame in the last n target detection frames, wherein 1≤m≤n; and determining the scaling coefficient according to n scaling coefficients.

In some embodiments, the scaling coefficient is an average value of the n scaling coefficients.

In some embodiments, determining whether a number of the all target detection frames is greater than a preset number threshold after detecting the all target detection frames in the original image; and sorting the all target detection frames according to the area sizes in a case where the number of the all target detection frames is greater than the first number threshold.

In some embodiments, dividing the original image into the plurality of sub-images with preset height and preset width in a case where the number of the all target detection frames is less than or equal to the first number threshold.

In some embodiments, each target detection frame among the all target detection frames comprises position information, and the dividing the original image in the direction of the depth of field from small to large comprises: clustering the all target detection frames according to the position information to obtain a clustering result; dividing the original image into a first image area and a second image area according to the clustering result, wherein the first image area comprises the all target detection frames, and the second image area does not comprise any target detection frame among the all target detection frames; and dividing the first image area in the direction of the depth of field from small to large.

In some embodiments, the each sub-image is acquired by an image acquisition device, and different sub-images have different acquisition points.

According to a second aspect of an embodiment of the present disclosure, there is provided an target detection device, comprising: a processor; and a memory coupled to the processor, storing program instructions which, when executed by the processor, cause the processor to implement the target detection method according to any of the above embodiments.

According to a third aspect of an embodiment of the present disclosure, there is provided a non-transient computer-readable storage medium, wherein non-transient computer-readable storage medium stores computer instructions which, when executed by a processor, implement the target detection method according to any of the above embodiments.

Other features and advantages of the present disclosure will become clear through detailed descriptions of the illustrative embodiments of the present disclosure with reference to the following accompanying drawings.

### BRIEF DESCRIPTION OF THE DRAWINGS

The accompanying drawings, which form a part of the description, describe the embodiments of the present disclosure, and are used to explain the principle of the present disclosure together with the description.

The present disclosure can be comprehended more clearly with reference to the accompanying drawings and according to the following detailed descriptions, wherein:

FIG. 1 is a flow schematic diagram of an target detection method according to one embodiment of the present disclosure;

FIGS. 2A-2B are schematic diagrams of an image according to some embodiments of the present disclosure;

FIG. 3 is a flow schematic diagram of an image dividing method according to one embodiment of the present disclosure;

FIG. 4 is a schematic diagram of an image according to another embodiment of the present disclosure;

FIGS. 5A-5E are schematic diagrams of direction attributes of target detection frames according to some embodiments of the present disclosure;

FIGS. 6-12 are schematic diagrams of sub-image merging according to some embodiments of the present disclosure;

FIG. 13 is a structural schematic diagram of an target detection device according to an embodiment of the present disclosure.

It shall be understood that the various parts shown in the accompanying drawings are not drawn in sizes according to actual proportional relations. In addition, the same or similar reference numerals indicate the same or similar components.

### DESCRIPTION OF THE INVENTION

Various illustrative embodiments of the present disclosure will now be described in detail with reference to the accompanying drawings. The descriptions of the illustrative embodiments are only illustrative, but shall not serve as limitations on the present disclosure and its application or utilization. The present disclosure can be implemented in many different forms and is not limited to the embodiments described herein. These embodiments are provided to make the present disclosure thorough and complete, and to fully express the scope of the present disclosure to those skilled in the art. It should be noted that unless otherwise illustrated, the relative arrangements of the components and steps, the components of the materials, and values set forth in these embodiments are to be construed as illustrative only and not as a limitation.

The terms “first”, “second” and similar wordings used in the present disclosure do not mean any order, quantity or importance, but are used only to discriminate different parts. The words “include” or “comprise” and the like mean that the elements preceding the word contain the elements listed after the word, and do not exclude the possibility of containing other elements.

All terms (including technical or scientific terms) used in the present disclosure have the same meaning as those understood by one ordinary skilled in the art to which the present disclosure belongs, unless specifically defined otherwise. It shall be further understood that, the terms as defined in a common dictionary shall be interpreted as having meanings consistent with those in the context of the relevant technique, instead of being interpreted with an idealistic or extremely formalized meaning, unless it is explicitly defined here.

Techniques, methods and devices that have already been known to ordinary skilled in the art may not be discussed here in details, but under suitable circumstances, the techniques, methods and devices shall be deemed as parts of the description.

The inventor found that in the same image, the pixel magnitudes of the targets at different positions vary significantly. This situation is more obvious for ultra-high definition images. For example, in the same image, the pixel magnitude of the target closer to the image acquisition device can reach several thousand, while the pixel magnitude of the target farther from the image acquisition device is only a few dozen. Therefore, after the image is compressed, the target farther from the image acquisition device in the image will be too small to be detected.

For example, for images with large depth of field or high-definition images acquired by a wide-angle image acquisition device, the target in the near view is larger, while the target in the distant view is smaller. In this case, the target detection model generates a larger target detection frame for the target located in the near view, but generates a smaller target detection frame for the target located in the distant view. Because the target detection model detects the targets based on the same detection standard, different target detection frames will greatly affect the target detection result. For example, because the target detection frame in the distant view is small, the detailed features of the target cannot be detected, and even the target in the distant view cannot be detected. For another example, since the target detection frame in the near view is large, it is difficult to detect the macro features of the target, which reduces the accuracy of target detection and further affects the subsequent processing of target detection, such s the inability to effectively realize target tracking and target thermal map conversion.

Accordingly, the present disclosure provides an target detection solution, which can effectively detect the target with a smaller pixel magnitude in an image and effectively improve the accuracy of target detection.

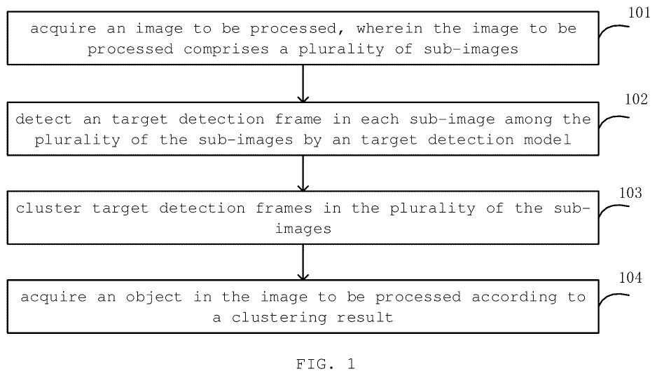

FIG. 1 is a flow schematic diagram of an target detection method according to one embodiment of the present disclosure. In some embodiments, the target detection method is performed by an target detection device.

In step 101, an image to be processed is acquired, wherein the image to be processed includes a plurality of sub-images.

In some embodiments, an original image is divided to obtain the image to be processed, wherein the image to be processed comprises a plurality of sub-image rows, and one sub-image row comprises a plurality of sub-images with a same size, and sizes of sub-images in the plurality of the sub-image rows decrease sequentially in a direction of depth of field of the original image from small to large.

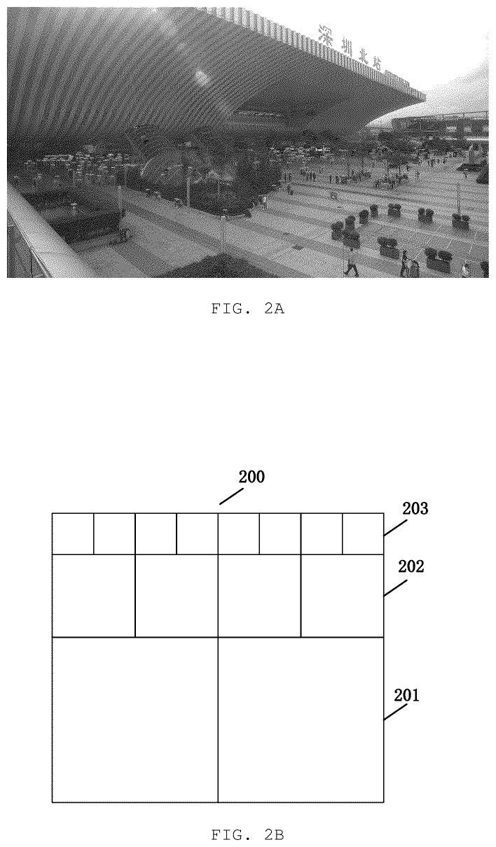

In some embodiments, as shown in FIG. 2B, an original image 200 shown in FIG. 2A is divided into a sub-image row 201, a sub-image row 202 and a sub-image row 203. Each sub-image row includes a plurality of sub-images with the same size.

It should be noted that, as shown in FIG. 2A, the lower area of the image is closer to the image acquisition device, that is, the depth of field is smaller, while the upper area of the image is farther from the image acquisition device, that is, the depth of field is larger. In this case, as shown in FIG. 2B, the image 200 is divided into three rows in the direction from bottom to top, namely, the sub-image row 201, the sub-image row 202 and the sub-image row 203. Among the sub-image row 201, the sub-image row 202 and the sub-image row 203, the size of each sub-image in the sub-image row 201 is the largest, and the size of each sub-image in the sub-image row 203 is the smallest.

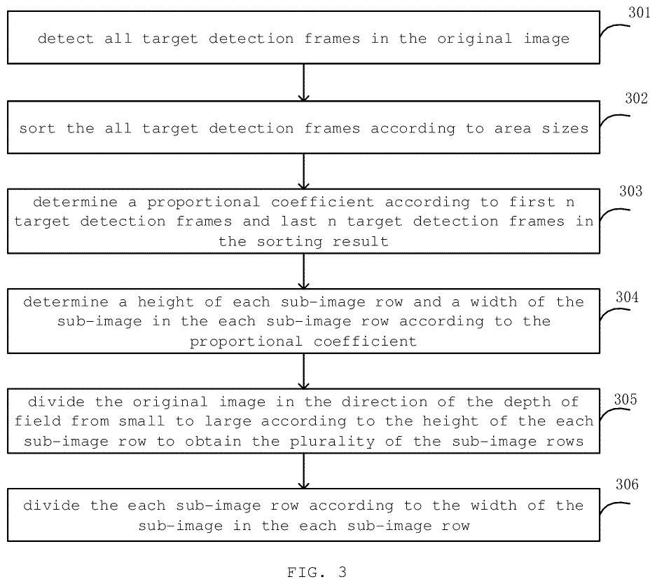

In some embodiments, the method for dividing the original image is shown in FIG. 3.

In step 301, all target detection frames in the original image are detected.

In step 302, the all target detection frames are sorted by area sizes of the all target detection frames.

In some embodiments, it is determined whether the number of the all target detection frames is greater than a preset number threshold after the all target detection frames in the original image are detected. In a case where the number of the all target detection frames is greater than a first number threshold, all target detection frames are sorted according to the area sizes. On the contrary, in a case where the number of the all target detection frames is less than or equal to the first number threshold, the original image is divided into the plurality of sub-images with preset height and preset width.

It should be noted that if the number of the all target detection frames in the original image is large, for example, the number of the all target detection frames in the original image is more than 20, the original image is divided according to the subsequent flow of the embodiment shown in FIG. 3. On the contrary, if the number of the all target detection frames in the original image is small, for example, the number of the all target detection frames in the original image is less than 20, if the original image is divided according to the subsequent flow of the embodiment shown in FIG. 3, the calculation cost will be high. Therefore, in a case where the number of the all target detection frames in the original image is small, the original image is directly divided into a plurality of sub-images with preset height and preset width, thus effectively saving the calculation cost and improving the target detection efficiency.

In step 303, the proportional coefficient is determined according to first n target detection frames and last n target detection frames in the sorting result.

For example, the parameter n is 10% of the total number of the target detection frames.

In some embodiments, the m-th scaling coefficient is determined according to the size of the m-th target detection frame in the first n target detection frames and the size of the (n−m+1)-th target detection frame in the last n target detection frames, wherein 1≤m≤n. Next, the proportional coefficient is determined according to the n scaling coefficients.

It should be noted here that the affine transformation parameters are determined according to the size of the m-th target detection frame in the first n target detection frames and the size of the (n−m+1)-th target detection frame in the last n target detection frames, and the affine transformation parameters are shown in Formula (1).

$$[ \begin{matrix}{\overline{a}}_{00} & {\overline{a}}_{01} & {\overline{b}}_{00} \\ {\overline{a}}_{10} & {\overline{a}}_{11} & {\overline{b}}_{10}\end{matrix} ] \qquad ( 1 )$$

It should be noted that in Formula (1), parameters ā₀₀ and ā₁₁ are scaling parameters in the affine transformation, parameters ā₀₁ and ā₁₀ are rotation parameters in the affine transformation, and parameters boo and bio are translation parameters in the affine transformation. The m-th scaling coefficient mentioned above is determined by the parameters ā₀₀ and ā₁₁. For example, the m-th scaling coefficient mentioned above=ā₀₀=ā₁₁.

In some embodiments, the proportional coefficient is an average of the n scaling coefficients.

It should be noted here that in order to effectively detect the target with a smaller pixel magnitude in the sub-image by the target detection model, the size of the sub-image needs to be determined reasonably, so that the size of the sub-image can meet the specific detection ability of the target detection model. If the area of the sub-image is too large, the target with a smaller pixel magnitude in the sub-image cannot be effectively detected. On the contrary, if the area of the sub-image is too small, the target cannot be detected effectively, such that the ideal detection result cannot be obtained.

For this reason, in the above embodiment of the present disclosure, the original image is first input into the target detection model, so that the target detection model outputs an target detection frame set. Through the target detection frame set, the specific detection ability of the target detection model can be known. Specifically, all target detection frames output by the target detection model are sorted according to the area sizes of the all target detection frames, the first target detection frame in the first n target detection frames and the first target detection frame in the last n target detection frames are taken as the first group, and the second target detection frame in the first n target detection frames and the second target detection frame in the last n target detection frames are taken as the second group, and so on, until the n-th target detection frame in the first n target detection frames and the n-th target detection frame in the last n target detection frames are taken as the n-th group. Next, a scaling coefficient is obtained according to the two target detection frames in each group, to obtain the n scaling coefficients. It should be noted here that a scaling coefficient obtained by the two target detection frames in the each group can reflect the detection ability of the target detection model. The proportional coefficient obtained by calculating the average value of the n scaling coefficients in the present disclosure can more accurately reflect the detection ability of the target detection model. That is to say, the size of the sub-image can be determined more reasonably according to the obtained proportional coefficient.

For example, 100 target detection frames are detected from the original image, and the 100 target detection frames are sorted according to the area sizes of the target detection frames to obtain an target detection frame queue. For example, in the target detection frame queue, the area of the first target detection frame is the largest, and the area of the 100th target detection frame is the smallest.

Next, in the target detection frame queue, the first scaling coefficient is determined according to the size of the first target detection frame in the first 10 target detection frames and the size of the tenth target detection frame in the last 10 target detection frames (that is, the 100th target detection frame in the target detection frame queue). The second scaling coefficient is determined according to the size of the second target detection frame in the first 10 target detection frames and the size of the ninth target detection frame in the last 10 target detection frames (that is, the 99th target detection frame in the target detection frame queue), and so on, until the tenth scaling coefficient is determined according to the size of the tenth target detection frame in the first 10 target detection frames and the size of the first target detection frame in the last 10 target detection frames (that is, the 91st target detection frame in the target detection frame queue).

Next, an average value from the first scaling coefficient to the tenth scaling coefficient is calculated as the proportional coefficient.

In some embodiments, the proportional coefficient is determined according to the size of the kth target detection frame in the first n target detection frames and the size of the kth target detection frame in the last n target detection frames, after the target detection frame queue are obtained. That is to say, the proportional coefficient is determined according to the size of one target detection frame in the first n target detection frames and the size of one corresponding target detection frame in the last n target detection frames.

For example, in the target detection frame queue, the first scaling coefficient is determined according to the size of the first target detection frame in the first 10 target detection frames and the size of the first target detection frame in the last 10 target detection frames (i.e., the 91st target detection frame in the target detection frame queue), and this first scaling system is taken as the proportional coefficient.

For another example, in the target detection frame queue, the second scaling coefficient is determined according to the size of the second target detection frame in the first 10 target detection frames and the size of the second target detection frame in the last 10 target detection frames (i.e., the 92nd target detection frame in the target detection frame queue), and this second scaling system is taken as the proportional coefficient.

In step 304, the height of the each sub-image row and the width of the sub-image in each sub-image row are determined according to the proportional coefficient.

In some embodiments, the transformation parameter of each sub-image row is firstly determined according to the proportional coefficient, and then the height of the each sub-image row is determined according to the preset height and the transformation parameter of the each sub-image row.

In some embodiments, the transformation parameter of the i-th sub-image row is the i-th power of the proportional coefficient, where 1≤i≤N, N is the total number of the sub-image rows. For example, the proportional coefficient is set to α, then the transformation parameter of the i-th sub-image row is aⁱ.

It should be noted here that the total number N of the sub-image rows can be adjusted as needed. If the total number N of the sub-image rows is increased, the height of the each sub-image row will be reduced. On the contrary, if the total number N of the sub-image rows is decreased, the height of the each sub-image row will be increased. That is to say, by adjusting the total number N of the sub-image rows, the size of each sub-image can be adjusted.

In some embodiments, the first calculation result is obtained by calculating the sum of the transformation parameters of the plurality of the sub-image rows. Next, the height of the i-th sub-image row is determined according to the preset height, the transformation parameter of the i-th sub-image row and the first calculation result.

It should be noted that the height of the i-th sub-image row is positively correlated with the transformation parameter of the i-th sub-image row and inversely correlated with the first calculation result.

In some embodiments, the ratio of the transformation parameter of the i-th sub-image row to the first calculation result is calculated to obtain the second calculation result, and the product of the preset height and the second calculation result is calculated to obtain the height of the i-th sub-image row.

For example, the height hᵢ of the i-th sub-image row is shown in Formula (2).

$${h}_{i} = h \times ( \frac{{a}^{i}}{{\sum }_{j = 1}^{N} {a}^{j}} ) \qquad ( 2 )$$

Where h is the preset height, N is the total number of sub-image rows, a′ is the transformation parameter of the i-th sub-image row, and

$${\sum }_{j = 1}^{N} {a}^{j}$$

is the first calculation result.

It should be noted here that the preset height h can be used to determine the size of the height hᵢ of the i-th sub-image row. As can be seen from the above Formula (2), the height hᵢ of the i-th sub-image row is determined by a product of the preset height h and a specified parameter, and the specified parameter is the ratio of the transformation parameter aⁱ of the i-th sub-image row to the first calculation result. As can be seen from the above Formula (2), since the specified parameter is less than 1, the height hᵢ of the i-th sub-image row must be less than the preset height h. That is to say, by setting the preset height h, the height of each sub-image row can be restricted from exceeding the preset height h.

In some embodiments, the width of the sub-image of the i-th sub-image row is determined according to the preset width and the transformation parameter of the i-th sub-image row.

It should be noted that the width of the sub-image of the i-th sub-image row is correlated positively with the transformation parameter of the i-th sub-image row.

In some embodiments, he width of the sub-image of the i-th sub-image row is obtained by calculating the product of the preset width and the transformation parameter of the i-th sub-image row.

For example, the width wᵢ of the sub-image of the i-th sub-image row is as shown in Formula (3).

$${w}_{i} = {a}^{i} \times w \qquad ( 3 )$$

Where w is the preset width, and aⁱ is the transformation parameter of the i-th sub-image row.

In some embodiments, the proportional coefficient α is less than 1. For example, the proportional coefficient α is 0.5. In this case, the transformation parameter aⁱ of the i-th sub-image row is greater than the transformation parameter aⁱ⁺¹ of the (i+1)-th sub-image row, so that the height hᵢ of the i-th sub-image row is greater than the height hᵢ₊₁ of the (i+1)-th sub-image row, and the width wᵢ of the sub-image of the i-th sub-image row is greater than the sub-image width wᵢ₊₁ of the (i+1)-th sub-image row. Thus, it can be seen from FIG. 2B that among the first sub-image row 201, the second sub-image row 202 and third sub-image row 203, the height of the first sub-image row 201 is the largest, and the width of the sub-image in the first sub-image row 201 is also the largest, while the height of the third sub-image row 203 is the smallest, and the width of the sub-image in the third sub-image row 203 is also the smallest.

In step 305, the original image is divided in the direction of the depth of field from small to large to obtain a plurality of sub-image rows according to the height of each sub-image row.

For example, as shown in FIG. 2A, the lower area of the image is closer to the image acquisition device, that is, the depth of field is smaller, while the upper area of the image is farther from the image acquisition device, that is, the depth of field is larger. In this case, as shown in FIG. 2B, in the direction from bottom to top, the image 200 is divided into three rows, namely, the sub-image row 201, the sub-image row 202 and the sub-image row 203, wherein the height h₁ of the sub-image row 201, the height h₂ of the sub-image row 202 and the height h₃ of the sub-image row 203 are obtained according to the above Formula (2), and h₁>h₂>h₃.

In some embodiments, each target detection frame among all target detection frames includes position information. For example, the position information is a coordinate array, which is used to indicate the position of the target detection frame in the original image. After all target detection frames are obtained through step 301, all target detection frames are clustered according to the position information to obtain a clustering result. The clustering result includes one or more clustering sets, each of which includes at least one target detection frame.

Next, the original image is divided into a first image area and a second image area according to the clustering result, wherein the first image area includes the all target detection frames. That is, the second image area does not include any target detection frame among the all target detection frames. Then, the first image area is divided in the direction of the depth of field from small to large.

It should be noted here that in some cases, there is target in each area of the image, and in this case, it is necessary to perform the target detection on each area of the image. In other cases, the targets in the image are mainly concentrated in one area. For example, in the original image involving the beach, the sea and the sky, the targets are mainly located on the beach, there are few targets in the sea and basically no target in the sky. If the target detection is performed on the whole original image in this case, it is obvious that the target detection for the sea area and sky area in the original image will not get valuable detection results, thus wasting computing resources and reducing the efficiency of target detection.

In order to improve the efficiency of the target detection, in the above embodiment of the present disclosure, each target detection frame among the all target detection frames is clustered according to the position information to obtain a clustering result. Through this clustering result, the position distribution of the all target detection frames in the original image can be known. Next, the original image is divided according to the clustering result to obtain the first image area and the second image area, wherein the first image area includes the all target detection frames. In this case, it is only necessary to perform the target detection on the first image area, but there is no need to perform the target detection on the second image area, thus effectively improving the efficiency of the target detection.

In the above mentioned embodiment, in the original image involving the beach, the sea and the sky, the targets are mainly located on the beach, there are few targets in the sea and basically no target in the sky. By clustering the each target detection frame among the all target detection frames in the original image according to the position information, the clustering result is obtained. According to the clustering result, the original image is divided into two image areas, the first image area includes the beach and a part of the sea near the beach, and the second image area includes a part of the sea far from the beach and the sky. Because there is no target in the second image area, it is unnecessary to perform the target detection on the second image area. In addition, because the first image area includes the all target detection frames in the original image, the target detection is only performed on the first image area in the original image, which will not affect the result of the target detection.

In some embodiments, if the clustering result includes two clustering sets, namely a first clustering set and a second clustering set, wherein the target detection frames in the first clustering set are all located on the beach, and the proportion of the total number of the target detection frames in the first clustering set to the all target detection frames in the original image exceeds a preset proportion, for example, the proportion exceeds 99%, in this case, in order to further improve the calculation efficiency, the original image can be divided into two image areas, in which the first image area includes the beach, and the second image area includes the sea and the sky. Because the first image area includes almost the all target detection frames in the original image, the target detection is only performed on the first image area in the original image, which will not affect the result of the target detection and can further improve the efficiency of the target detection at the same time.

In step 306, the each sub-image row is divided according to the width of the sub-image in each sub-image row.

For example, as shown in FIG. 2B, the plurality of the sub-images are divided in the sub-image row 201, wherein the width w₁ of the each sub-image in the sub-image row 201 is determined according to the above Formula (3). The plurality of the sub-images are divided in the sub-image row 202, wherein the width w₂ of the each sub-image in the sub-image row 202 is determined according to the above Formula (3). The plurality of the sub-images are divided in the sub-image row 203, wherein the width w₃ of each sub-image in the sub-image row 203 is determined according to the above Formula (3), and w₁>w₂>w₃.

In some embodiments, the each sub-image in the image to be processed is acquired by an image acquisition device, and different sub-images have different acquisition points, so that the each sub-image will have different pixel magnitudes.

For example, in the field of smart manufacturing, the target defect detection is performed by image identification of products. Because some defects are micron-scale and some defects are millimeter-scale, if the whole image of the product is identified, the defect of low pixel magnitude cannot be detected effectively. In order to solve this problem, the present disclosure proposes to collect the sub-images of the different areas of the product firstly, and then merge these sub-images to form a merged image. Next, the merged image is processed by using the solution provided by the present disclosure to detect the defect with different pixel magnitudes.

It should be noted here that the above mentioned acquisition points refer to the positions where an industrial camera is located when acquiring images of different areas of the product. Because the industrial camera has different acquisition points when acquiring sub-images in different areas, the each sub-image will have different pixel magnitude.

In some embodiments, as shown in FIG. 4, the image to be processed 400 is obtained by merging the sub-images acquired by the image acquisition device at different acquisition points.

It should be noted here that in order to detect the defects in the product by processing the image to be processed, there will be a partially overlapping area between two adjacent sub-images, to avoid the situation that the defect of the product cannot be detected due to the lack of a part of area of the product in the merged image to be processed.

In some embodiments, the ratio of the overlapping area of the two adjacent sub-images and the area of any one of the two sub-images is less than a preset threshold, to avoid the problem that the detected product defects do not match the actual situation because the area of the overlapping area is too large.

It should be noted here that FIG. 4 differs from FIG. 2B in that FIG. 4 is obtained by merging the sub-images acquired by the image acquisition device at different acquisition points, so the each sub-image in FIG. 4 has the same height and width. In this case, FIG. 4 can be divided in a different way to obtain a plurality of sub-image rows.

For example, in the direction from top to bottom, the image 400 is divided into three rows, namely, a sub-image row 411, a sub-image row 412 and a sub-image row 413.

For another example, in the direction from left to right, the image 400 is divided into four columns, namely, a sub-image column 421, a sub-image column 422, a sub-image column 423 and a sub-image column 424.

In step 102, an target detection frame in each sub-image among the plurality of the sub-images is detected by the target detection model.

It should be noted here that the target detection frame is used to indicate the position of the target in the sub-image.

Because the target detection frame is detected for each sub-image in the present disclosure, the target detection frame in each sub-image can be detected according to the pixel magnitude of the each sub-image, so that the targets with different pixel magnitudes can be detected.

For example, as shown in FIG. 2B, the pixel magnitude of the target in the sub-image in the sub-image row 201 is larger, so the sub-image can be compressed with a larger compression ratio, and the target detection frame in the sub-image is detected. The pixel magnitude of the target in the sub-image in the sub-image row 203 is smaller, so the sub-image can be compressed with a smaller compression ratio, and the target detection frame in the sub-image is detected. Therefore, the target detection frames with different pixel magnitudes in the image to be processed can be detected.

It should be noted here that the model usually has certain format requirements for the image when processing the image. For example, the image with pixel format of 1920×1440 or the image with pixel format of 1440×720 are uniformly adjusted to a pixel format of 720×640 according to the model requirements. In other words, the model will compress the image according to a certain compression ratio, to get the pixel format that meets the requirements.

In addition, it should be also noted that as shown in FIG. 2A, the lower area of the image is closer to the image acquisition device, so the pixel magnitude of the target located in the lower area of the image is larger. In this case, the lower area of the image is compressed with a larger compression ratio, and a better target detection result can still be obtained. That is, th each sub-image in the lower sub-image row 201 in FIG. 2B is compressed with a larger compression ratio, and a better target detection result can be obtained.

On the other hand, as shown in FIG. 2A, the upper area of the image is farther from the image acquisition device, so the pixel magnitude of the target located in the upper area of the image is smaller. In this case, if the upper area of the image is still compressed with a larger compression ratio, the pixel magnitude of the target located in the upper area of the image will be too small, and an ideal target detection result cannot be obtained. In order to avoid this problem, the upper area of the image is compressed with a smaller compression ratio to obtain a better target detection result. That is, the each sub-image in the upper sub-image row 203 in FIG. 2B is compressed with a smaller compression ratio, and a better target detection result can be obtained.

From the above analysis, it can be seen that because different areas of the same image have different pixel magnitudes, the compression ratios used in the target detection of sub-images located in different areas of the same image will be different.

It should also be noted that in the above step 102, since the pixel magnitudes of different sub-images are different, by using the target detection module to detect the sub-images with different pixel magnitudes, the target detection frames with different pixel magnitudes in the image to be processed can be detected, which is helpful to obtain more accurate target statistical result.

By obtaining more accurate target statistical result, the application scenarios of the target detection can be further expanded. For example, in the image to be processed, because the target A is partially obscured by the target B, only a part of the target A can be presented in the image to be processed. Since the pixel magnitude of this part is small, it is difficult to identify the target A according to the current target detection solution. However, in the above embodiment of the present disclosure, the image to be processed is divided to obtain the plurality of the sub-images, and the target detection is performed on the each sub-image by the target detection model, so that the target A with low pixel magnitude can be detected. That is, the obscured target can be detected by using the above embodiment of the present disclosure, thereby effectively solving the obscuring problem among the plurality of the targets.

For another example, in the scene of tracking the target, the tracking of the target vehicle is realized by identifying the images taken by cameras set at multiple intersections. Because different cameras have different acquiring angles, in some images, the pixel magnitude of the target vehicle is larger, while in other images, the pixel magnitude of the target vehicle is smaller. According to the current target detection solution, the target vehicle with larger pixel magnitude will be identified, while the target vehicle with smaller pixel magnitude is difficult to be identified. In this case, it is impossible to track the target vehicle effectively. However, in the above mentioned embodiment of the present disclosure, the image to be processed is divided to obtain the plurality of the sub-images, and the target detection is performed on each sub-image by the target detection model, so that not only the target vehicle with higher pixel magnitude in the image can be detected, but the target vehicle with lower pixel magnitude in the image can also be detected. Therefore, the trajectory of the target vehicle can be determined according to the detection result, that is, the problem of target tracking can be effectively solved.

It should also be noted here that the embodiment shown in FIG. 1 and the embodiment shown in FIG. 3, the image is processed by the target detection model, but the purpose of using the target detection model in the embodiment shown in FIG. 1 and the embodiment shown in FIG. 3 is different. In the embodiment shown in FIG. 3, the image is processed by the target detection model, the purpose of which is to determine the height and width of each sub-image in the process of dividing the image. However, in the embodiment shown in FIG. 1, the each sub-image included in the image is processed by the target detection model to identify the target detection frame in each sub-image respectively, so as to detect targets with different pixel magnitudes in the image.

In some embodiments, the target detection model includes the YOLOv7 model, or other suitable neural network models.

It should be noted that the YOLOv7 model is an target detection model based on convolutional neural network, which can perform target detection through transfer learning. The YOLOv7 model has the following advantages over other versions of YOLO (You Only Look Once) series:
1. Improvement of detection accuracy: the YOLOv7 model makes the detected target more accurate by improving the accuracy of the detection algorithm.
2. Fast speed: the YOLOv7 model is faster than the previous version, and can process a large number of images in a short time.
3. Supporting high-resolution images: the YOLOv7 model supports the processing of the high-resolution images, so it can be used for higher-precision target detection.
4. Supporting multiple types of targets: the YOLOv7 model can detect multiple types of targets, such as people, cars, articles, etc., so a detection frame type attribute can be set for the target detection frame of the each target, and through the detection frame type attribute of the target detection frame, it can be known that the targets in the target detection frame are people, cars, animals, plants, buildings and other types. For example, the YOLOv7 model can provide more than 80 kinds of the detection frames.
5. Better adaptability: the YOLOv7 model can meet the requirements of target detection in different environments, so it can be used in various scenarios.

In step 103, the target detection frames in the plurality of the sub-images are clustered.

In some embodiments, the plurality of the sub-images are merged, and adjacent target detection frames with opposite direction attributes are clustered.

It should be noted that the detection frame type of the adjacent target detection frames for clustering is the same, and the distance between the centers of the adjacent target detection frames is less than a distance threshold.

For example, the detection result given by the YOLOv7 model consists of an array, in which part of the contents of the array relates to the detection frame type of the target detection frame.

In order to facilitate the clustering of target detection frames, it is necessary to determine the direction attribute of each target detection frame located in the sub-image.

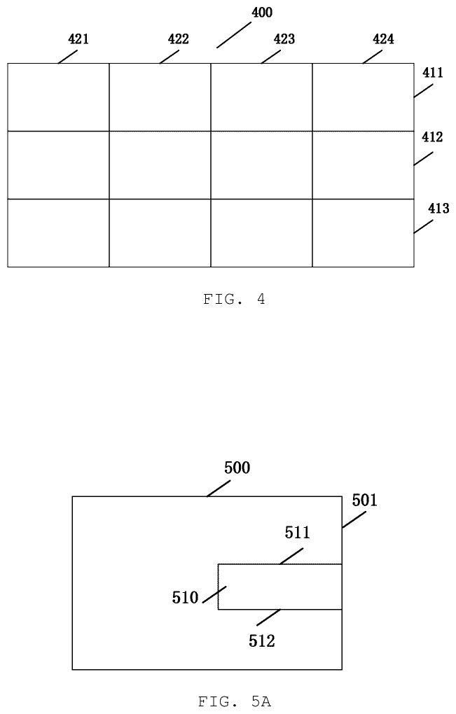

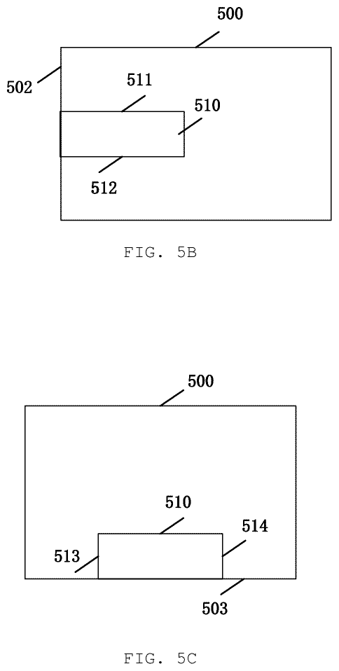

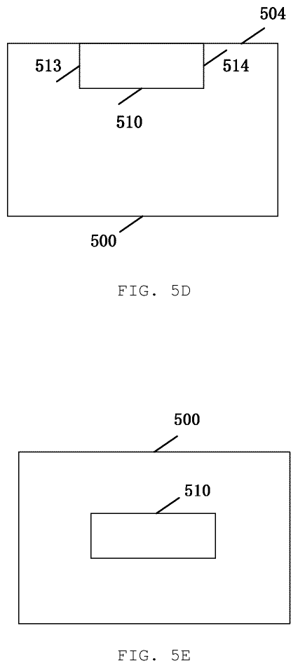

For example, as shown in FIG. 5A, the target detection frame 510 is located in a sub-image 500. Let the direction from left to right be the first direction. If two sides 511 and 512 of the target detection frame 510 parallel to the first direction intersect with one side 501 of the sub-image 500 in the first direction, the direction attribute of the target detection frame 510 is the first direction. If the first direction is from left to right, the direction attribute of the target detection frame 510 is to the right.

As shown in FIG. 5B, the target detection frame 510 is located in the sub-image 500. Let the direction from left to right be the first direction. If two sides 511 and 512 of the target detection frame 510 parallel to the first direction intersect with one side 502 of the sub-image 500 in the opposite direction of the first direction, the direction attribute of the target detection frame 510 is the direction opposite to the first direction. If the first direction is from left to right, the direction attribute of the target detection frame 510 is to the left.

As shown in FIG. 5C, the target detection frame 510 is located in the sub-image 500. Let the direction from top to bottom be the second direction. If two sides 513 and 514 of the target detection frame 510 parallel to the second direction intersect with one side 503 of the sub-image 500 in the second direction, the direction attribute of the target detection frame 510 is the second direction. If the second direction is from top to bottom, the direction attribute of the target detection frame 510 is downward.

As shown in FIG. 5D, the target detection frame 510 is located in the sub-image 500. Let the direction from top to bottom be the second direction. If two sides 513 and 514 of the target detection frame 510 parallel to the second direction intersect with one side 504 of the sub-image 500 in the opposite direction of the second direction, the direction attribute of the target detection frame 510 is the direction opposite to the second direction. If the second direction is from top to bottom, the direction attribute of the target detection frame 510 is upward.

As shown in FIG. 5E, the target detection frame 510 is located in the sub-image 500, and the target detection frame 510 does not intersect with the sub-image 500. In this case, it is considered that the target detection frame 510 has no direction attribute.

For example, sub-image 1 and sub-image 2 are adjacent, and sub-image 2 is located on the right side of sub-image 1. Sub-image 1 includes the target detection frame P₁₁, the target detection frame P₁₂, . . . , and the target detection frame Pin, while sub-image 2 includes the target detection frame P₂₁, the target detection frame P₂₂, . . . , and the target detection frame P₂ₘ. The similarity matrix S generated based on the plurality of the target detection frames in sub-image 1 and the plurality of the target detection frames in sub-image 2 is shown in Formula (4).

$$S = [ \begin{matrix}f ( {P}_{11} , {P}_{21} ) & … & f ( {P}_{11} , {P}_{2 m} ) \\ ⋮ & ⋱ & ⋮ \\ f ( {P}_{1 n} , {P}_{21} ) & … & f ( {P}_{1 n} , {P}_{2 m} )\end{matrix} ] \qquad ( 4 )$$

Where in the similarity matrix S, the function ƒ is shown in Formula (5).

$$f ( {P}_{1 i} , {P}_{2 j} ) = ClassMatch ( {P}_{1 i} , {P}_{2 j} ) \times DirectionMatch ( {P}_{1 i} , {P}_{2 j} ) \times cosMatch ( {P}_{1 i} , {P}_{2 j} ) \qquad ( 5 )$$

Where ClassMatch is the type matching function of the target detection frame, DirectionMatch is the direction matching function of the target detection frame, and cosMatch is the center distance matching function of the target detection frame.

For example, if the target detection frame types of P₁ᵢ and P₂ⱼ are matched, then the ClassMatch (P₁ᵢ, P₂ⱼ) is 1. On the contrary, if the target detection frame types of P₁ᵢ and P₂ⱼ are not matched, then the ClassMatch (P₁ᵢ, P₂ⱼ) is 0. If the direction attribute of P₁ᵢ is to the right and the direction attribute of P₂ⱼ is to the left, then it is considered that the direction attributes of P₁ᵢ and P₂ⱼ are matched, and the DirectionMatch(P₁ᵢ, P₂ⱼ) is 1. If the direction attributes of P₁ᵢ and P₂ⱼ are not matched, for example, the direction attribute of P₁ᵢ is to the right and the direction attribute of P₂ⱼ is downward, then it is considered that the direction attributes of P₁ᵢ and P₂ⱼ are not matched, and the DirectionMatch(P₁ᵢ, P₂ⱼ) is 0. The cosMatch(P₁ᵢ, P₂ⱼ) scores the cosine similarity between the center distance of P₁ᵢ, and the center distance of P₂ⱼ. Therefore, the value of the function ƒ(P₁ᵢ, P₂ⱼ) is determined together by the target detection frame types of P₁ᵢ and P₂ⱼ, the direction attributes of P₁ᵢ and P₂ⱼ, and the cosine similarity between the center distance of P₁ᵢ and the center distance of P₂ⱼ.

In some embodiments, in the process of merging a plurality of the sub-images, firstly, the sub-images in each sub-image row of the image to be processed are merged along a first direction, to cluster the first target detection frame whose direction attribute is the first direction and an adjacent second target detection frame whose direction attribute is opposite to the first direction.

Next, the sub-image rows of the image to be processed are merged along the second direction, to cluster the third target detection frame whose direction attribute is the second direction and the adjacent fourth target detection frame whose direction attribute is opposite to the second direction, wherein the second direction intersects with the first direction.

For example, the first direction is from left to right, and the second direction is from top to bottom.

In some embodiments, the merging the sub-images in the each sub-image row along the first direction comprises the following steps.

1. the direction attribute of the target detection frame in the each sub-image is detected.

2. the first sub-image in the first direction is taken as the merging sub-image.

3. the first merging process on the merging sub-image and the adjacent second sub-image in the first direction is performed, to update the merging sub-image.

4. the direction attribute of the current target detection frame in the merging sub-image is detected.

5. the first merging process is repeatedly performed until the merging sub-image has no adjacent second sub-image in the first direction.

This is described below through specific embodiment.

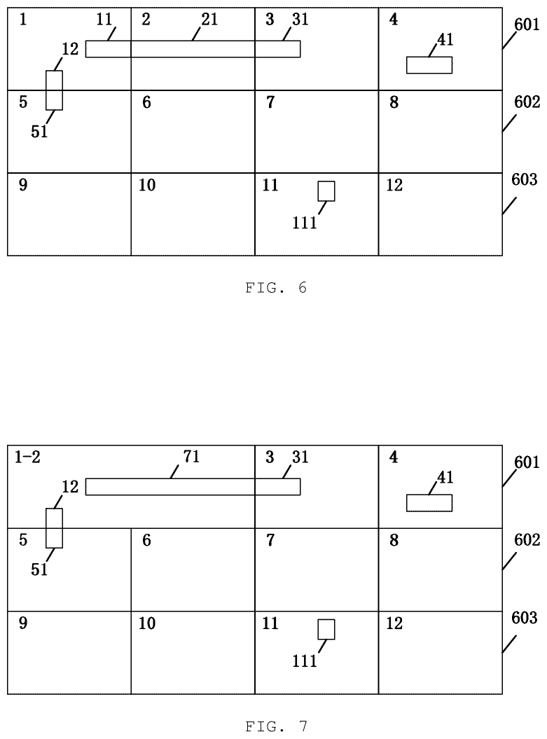

As shown in FIG. 6, according to the direction from top to bottom, the image to be processed is divided into three rows, namely, the sub-image row 601, the sub-image row 602 and the sub-image row 603. The sub-image row 601 includes the sub-image 1 to the sub-image 4, the sub-image row 602 includes the sub-image 5 to the sub-image 8, and the sub-image row 603 includes the sub-image 9 to the sub-image 12.

In the sub-image 1, the direction attribute of the target detection frame 11 is to the right, and the direction attribute of the target detection frame 12 is downward. In the sub-image 2, the direction attribute of the target detection frame 21 is to the left and to the right. In the sub-image 3, the direction attribute of the target detection frame 31 is to the left. In the sub-image 4, the target detection frame 41 has no direction attribute. In the sub-image 5, the direction attribute of the target detection frame 51 is upward. In the sub-image 11, the target detection frame 111 has no direction attribute.

In the sub-image row 601, the sub-image 1 and the sub-image 2 are merged to obtain the merged sub-image 1-2, and the target detection frame 11 and the target detection frame 21 that meet the merging conditions are merged to obtain the target detection frame 71, as shown in FIG. 7. At this time, the direction attribute of the target detection frame 71 is to the right.

It should be noted that the direction attributes of the target detection frame 11 and the target detection frame 21 are opposite, the detection frame types of the target detection frame 11 and the target detection frame 21 are the same, and the distance between the center of the target detection frame 11 and the center of the target detection frame 21 is smaller than a distance threshold. Therefore, the target detection frame 11 and the target detection frame 21 meet the merging conditions.

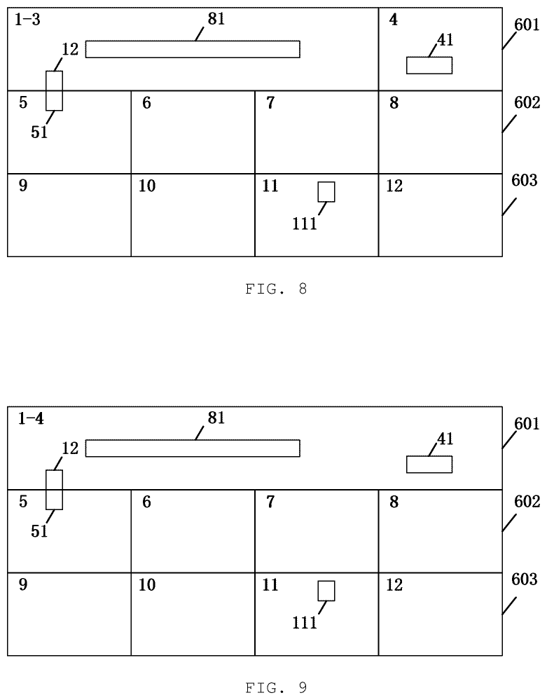

Next, in the sub-image row 601, the merged sub-image 1-2 and the sub-image 3 are merged to obtain a merged sub-image 1-3, and the target detection frame 71 and the target detection frame 31 that meet the merging conditions are merged to obtain the target detection frame 81, as shown in FIG. 8. At this time, the target detection frame 81 has no direction attribute.

It should be noted here that if each sub-image is detected, it can only be detected that sub-image 1 includes the target detection frame 11, sub-image 2 includes the target detection frame 21, and sub-image 3 includes the target detection frame 31, but it cannot be further determined whether these three target detection frames belong to the same target. Through the above processing, the target detection frame 11, the target detection frame 21, and the target detection frame 31 are merged into the target detection frame 81, so that the target across the sub-images can be detected.

For example, in the field of quality detection, defects spanning multiple sub-images can be detected according to the solution provided by the present disclosure.

Next, in the sub-image row 601, the merged sub-image 1-3 and the sub-image 4 are merged to obtain a merged sub-image 1-4, that is, there is only one sub-image in the sub-image row 601 at this time, as shown in FIG. 9. Since the target detection frame 81 and the target detection frame 41 do not meet the merging conditions, the target detection frame 81 and the target detection frame 41 are not merged.

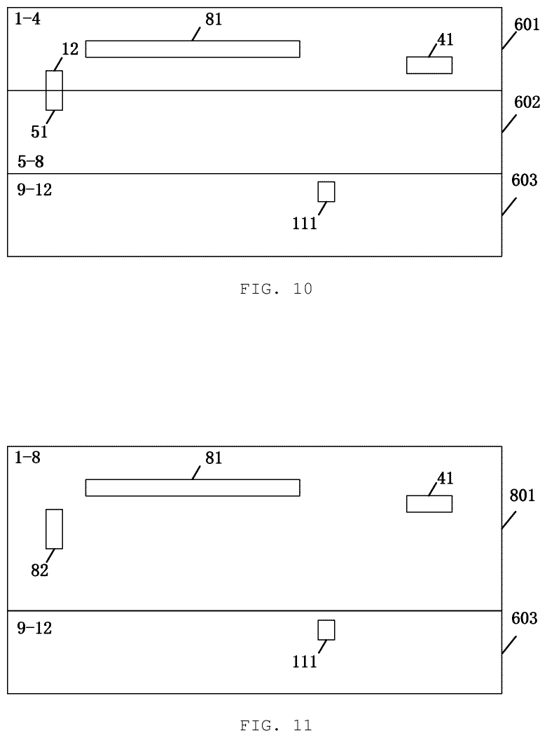

According to the above method, the sub-images in the sub-image row 602 are merged to obtain a merged sub-image 5-8, and the sub-images in the sub-image row 603 are merged to obtain a merged sub-image 9-12, as shown in FIG. 10.

In some embodiments, the sub-image rows of the image to be processed are merged along the second direction comprises the following steps.

1. the first sub-image row in the second direction is taken as the merging sub-image row.

2. the second merging process on the merging sub-image row and the adjacent second sub-image row in the second direction is performed, to update the merging sub-image row.

3. the direction attribute of the current target detection frame in the merging sub-image row is detected.

4. the second merging process is repeatedly performed until the merging sub-image row has no adjacent sub-image row in the second direction.

This is described below through specific embodiments.

As shown in FIG. 10, according to the direction from top to bottom, the image to be processed is divided into three rows, namely, the sub-image row 601, the sub-image row 602 and the sub-image row 603. The sub-image row 601 includes the merged sub-image 1-4, the sub-images row 602 includes the merged sub-image 5-8, and the sub-image row 603 includes the merged sub-image 9-12.

In the direction from top to bottom, the sub-image row 601 and sub-image row 602 are first merged to generate the merged sub-image row 801, that is, the merged sub-image 1-4 and the merged sub-image 5-8 are merged to obtain a merged sub-image 1-8, and the target detection frame 12 and the target detection frame 51 that meet the merging conditions are merged to obtain an target detection frame 82, as shown in FIG. 11. At this time, the target detection frame 82 has no direction attribute.

It should be noted that the direction attributes of the target detection frame 12 and the target detection frame 51 are opposite, the detection frame types of the target detection frame 12 and the target detection frame 51 are the same, and the distance between the center of the target detection frame 12 and the center of the target detection frame 51 is less than the distance threshold. Therefore, the target detection frame 12 and the target detection frame 51 meet the merging conditions.

Thus, by merging the target detection frame 12 and the target detection frame 51 to obtain the target detection frame 82, the target across the sub-images can be detected.

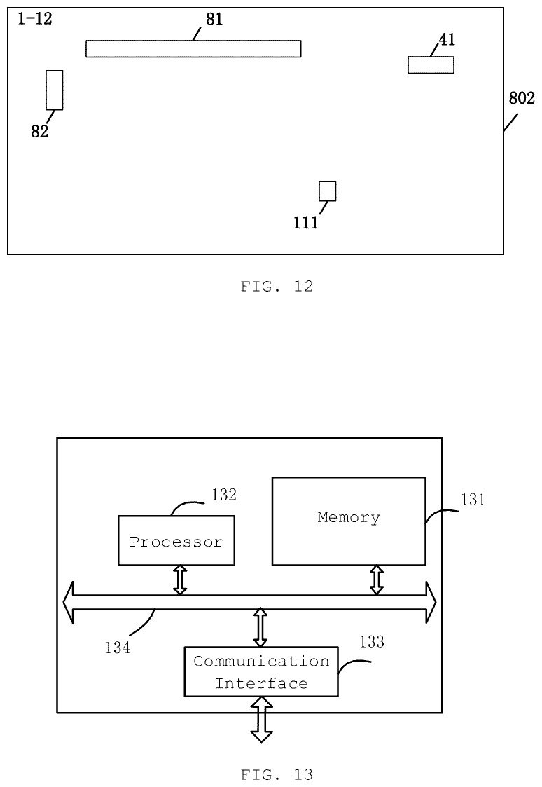

Next, the merged sub-image row 801 and the sub-image row 603 are merged to obtain the merged sub-image row 802, that is, the merged sub-image 1-8 and the merged sub-image 9-12 are merged to obtain a merged sub-image 1-12, as shown in FIG. 12. At this time, there is no target detection frame meeting the merging conditions.

It should be noted that the merged sub-image 1-12 is equivalent to the image to be processed.

In step 104, the target in the image to be processed is obtained according to the clustering result.

For example, as shown in FIG. 12, according to the clustering result, it can be determined that the image to be processed includes four targets, wherein the first target corresponds to the target detection frame 81, the second target corresponds to the target detection frame 82, the third target corresponds to the target detection frame 41, and the fourth target corresponds to the target detection frame 111.

Through the target detection method provided by the above embodiments of the present disclosure, by detecting the target detection frame included in the each sub-image of the plurality of the sub-images in the image to be processed and clustering the target detection frames in the plurality of the sub-images, the targets with different pixel magnitudes can be detected, and the target across sub-images can be effectively detected.

FIG. 13 is a structural schematic diagram of an target detection device according to an embodiment of the present disclosure. As shown in FIG. 13, the target detection device includes a memory 131 and a processor 132.

The memory 131 is used to store instructions. The processor 132 is coupled to the memory 131. The processor 132 is configured to implement the method according to any one of the embodiments in FIG. 1 and FIG. 3 based on instructions stored in the memory.

As shown in FIG. 13, the target detection device further includes a communication interface 133 for information interaction with other devices. Meanwhile, the target detection device also includes a bus 134 through which the processor 132, the communication interface 133 and the memory 131 communicate with each other.

The memory 131 may include a high-speed RAM (Random Access Memory) or a NVM (Non-Volatile Memory), such as at least one disk storage. The memory 131 may also be a memory array. The memory 131 may also be partitioned, and the blocks may be combined into a virtual volume according to certain rules.

In addition, the processor 132 may be a central processing unit, or may be an ASIC (Application Specific Integrated Circuit), or one or more integrated circuits configured to implement the embodiments of the present disclosure.

In some embodiments, the transparent display panel control device can be arranged in a SoC (System on Chip) board, an FPGA (Field Programmable Gate Array) board or a GPU (Graphics Processing Unit).

The present disclosure also provides a non-transient computer-readable storage medium. The computer-readable storage medium stores computer instructions, which, when executed by a processor, implement the method according to any one of the embodiments in FIG. 1 and FIG. 3.

Heretofore, the embodiments of the present disclosure have been described in details. In order to avoid shielding of the concept of the present disclosure, some details commonly known in the art are not described. Based on the above description, those skilled in the art can fully understand how to carry out the technical solutions disclosed herein.

While some specific embodiments of the present disclosure have been described in details by way of examples, those skilled in the art should understand that the above examples are for illustrative purposes only and are not intended to limit the scope of the present disclosure. Those skilled in the art will appreciate that the above embodiments may be modified or an equivalent substitution may be performed on some of the technical features without departing from the scope and spirit of the present disclosure. The scope of the present disclosure is defined by the appended claims.

1. A target detection method, comprising:
acquiring an image to be processed, wherein the image to be processed comprises a plurality of sub-images;
detecting a target detection frame in each sub-image among the plurality of the sub-images by a target detection model;
clustering target detection frames in the plurality of the sub-images to obtain a clustering result; and
acquiring a target in the image to be processed according to the clustering result.

2. The target detection method according to claim 1, wherein the clustering the target detection frames in the plurality of the sub-images comprises:
merging the plurality of the sub-images; and
clustering adjacent target detection frames with opposite direction attributes.

3. The target detection method according to claim 2, wherein
the adjacent target detection frames are of the same detection frame type, and a distance between centers of the adjacent target detection frames is less than a distance threshold.

4. The target detection a method according to claim 2, wherein the merging the plurality of the sub-images comprises:
merging sub-images in each sub-image row of the image to be processed along a first direction, to cluster a first target detection frame, of which direction attribute is the first direction and an adjacent second target detection frame, of which direction attribute is opposite to the first direction; and
merging sub-image rows of the image to be processed along a second direction to cluster a third target detection frame, of which direction attribute is the second direction and an adjacent fourth target detection frame, of which direction attribute is opposite to the second direction, wherein the second direction intersects with the first direction.

5. The target detection method according to claim 4, wherein the merging the sub-images along the first direction comprises:
detecting a direction attribute of the target detection frame in the each sub-image;
taking a first sub-image in the first direction as a merging sub-image;
performing a first merging process on the merging sub-image and an adjacent second sub-image in the first direction, to update the merging sub-image;
detecting a direction attribute of a current target detection frame in the merging sub-image; and
repeatedly performing the first merging process until the merging sub-image has no adjacent second sub-image in the first direction;
and/or
wherein the merging the sub-image rows along the second direction comprises:
taking a first sub-image row in the second direction as a merging sub-image row;
performing a second merging process on the merging sub-image row and an adjacent second sub-image row in the second direction, to update the merging sub-image row;
detecting direction attribute of a current target detection frame in the merging sub-image row; and
repeatedly performing the second merging process until the merging sub-image row has no adjacent second sub-image row in the second direction.

6. (canceled)

7. The target detection method according to claim 4, wherein,
two sides of the first target detection frame parallel to the first direction intersect with one side of a sub-image where the first target detection frame is located in the first direction;
two sides of the second target detection frame parallel to the first direction intersect with one side of a sub-image where the second target detection frame is located in an opposite direction of the first direction;
two sides of the third target detection frame parallel to the second direction intersect with one side of a sub-image where the third target detection frame is located in the second direction; and
two sides of the fourth target detection frame parallel to the second direction intersect with one side of a sub-image where the fourth target detection frame is located in an opposite direction of the second direction.

8. The detection method according to claim 1, wherein the acquiring the image to be processed comprises:
dividing an original image to obtain the image to be processed, wherein the image to be processed comprises a plurality of sub-image rows, and one of the sub-image rows comprises a plurality of sub-images with a same size, and sizes of sub-images in the plurality of the sub-image rows decrease sequentially in a direction of depth of field of the original image from small to large.

9. The target detection method according to claim 8, wherein the dividing the original image comprises:
detecting all target detection frames in the original image;
sorting the all target detection frames according to area sizes of the all target detection frames;
determining a proportional coefficient according to first n target detection frames and last n target detection frames in a sorting result;
determining a height of each sub-image row and a width of the sub-image in the each sub-image row according to the proportional coefficient;
dividing the original image in the direction of the depth of field from small to large according to the height of the each sub-image row to obtain the plurality of the sub-image rows; and
dividing the each sub-image row according to the width of the sub-image in the each sub-image row.

10. The method according to claim 9, wherein the determining the height of the each sub-image row according to the proportional coefficient comprises:
determining a transformation parameter of the each sub-image row according to the proportional coefficient; and
determining the height of the each sub-image row according to a preset height and the transformation parameter of the each sub-image row;
and/or
determining whether a number of the all target detection frames is greater than a preset number threshold after detecting the all target detection frames in the original image;
sorting the all target detection frames according to the area sizes in a case where the number of the all target detection frames is greater than the first number threshold; and
dividing the original image into the plurality of sub-images with preset height and preset width in a case where the number of the all target detection frames is less than or equal to the first number threshold;
and/or
wherein each target detection frame among the all target detection frames comprises position information, and the dividing the original image in the direction of the depth of field from small to large comprises:
clustering the all target detection frames according the position information to obtain a clustering result;
dividing the original image into a first image area and a second image area according to the clustering result, wherein the first image area comprises the all target detection frames, and the second image area does not comprise any target detection frame among the all target detection frames; and
dividing the first image area in the direction of the depth of field from small to large.

11. The target detection method according to claim 10, wherein the determining the height of the each sub-image row according to the preset height and the transformation parameter of the each sub-image row comprises:
calculating a sum of transformation parameters of the plurality of the sub-image rows to obtain a first calculation result; and
determining a height of an i-th sub-image row according to the preset height, a transformation parameter of the i-th sub-image row and the first calculation result, wherein 1≤i≤N, and N is a total number of the sub-image rows.

12. The target detection method according to claim 11, wherein
the height of the ith sub-image row is positively correlated with the transformation parameter of the ith sub-image row and inversely correlated with the first calculation result.

13. The target detection method according to claim 12, wherein the determining the height of the i-th sub-image row comprises:
calculating a ratio of the transformation parameter of the i-th sub-image row to the first calculation result to obtain a second calculation result; and
calculating a product of the preset height and the second calculation result to obtain the height of the i-th sub-image row.

14. The target detection method according to claim 13, wherein the determining the width of the sub-image of the each sub-image row according to the proportional coefficient comprises:
determining the width of the sub-image of the i-th sub-image row according to the preset width and the transformation parameter of the i-th sub-image row.

15. The detection method according to claim 14, wherein,
the width of the sub-image of the ith sub-image row is positively correlated with the transformation parameter of the ith sub-image row.

16. The targe detection method according to claim 14, wherein the determining the width of the sub-image of the i-th sub-image row comprises:
calculating a product of the preset width and the transformation parameter of the i-th sub-image row to obtain the width of the sub-image of the i-th sub-image row.

17. The method according to claim 14, wherein,
the transformation parameter of the ith sub-image row is an ith power of the proportional coefficient.

18. The target detection method according to claim 9, wherein the determining the proportional coefficient according to the first n target detection frames and the last n target detection frames in the sorting result comprises:
determining a m-th scaling coefficient according to a size of a m-th target detection frame in the first n target detection frames and a size of a (n−m+1)-th target detection frame in the last n target detection frames, wherein 1≤m≤n; and
determining the scaling coefficient according to n scaling coefficients.

19. The target detection method according to claim 18, wherein,
the scaling coefficient is an average value of the n scaling coefficients.

20-23. (canceled)

24. A target detection device, comprising:
a processor; and
a memory coupled to the processor, storing program instructions which, when executed by the processor, cause the processor to implement a targe detection method comprising:
acquiring an image to be processed, wherein the image to be process comprises a plurality of sub-images;
detecting a target detection frame in each sub-image among the plurality of the sub-images by a target detection model;
clustering target detection frames in the plurality of the sub-images to obtain a clustering result; and
acquiring a target in the image to be processed according to the clustering result.

25. A non-transient computer-readable storage medium, wherein the computer-readable storage medium stores computer instructions which, when executed by a processor, implement a target detection method comprising:
acquiring an image to be processed, wherein the image to be processed comprises a plurality of sub-images;
detecting a target detection frame in each sub-image among the plurality of the sub-images by a target detection model;
clustering target detection frames in the plurality of the sub-images to obtain a clustering result; and
acquiring a target in the image to be processed according to the clustering result.
